(19) United States
(12) Patent Application Publication
(10) Pub. No.: US 2018/0297545 A1
(43) Pub. Date: Oct. 18, 2018

(54) COLLISION DATA STORAGE DEVICE AND COLLISION DATA STORAGE METHOD

(71) Applicant: TOYOTA JIDOSHA KABUSHIKI KAISHA, Toyota-shi (JP)

(72) Inventor: Yosuke YAMAGUCHI, Toyota-shi (JP)

(73) Assignee: TOYOTA JIDOSHA KABUSHIKI KAISHA, Toyota-shi (JP)

(21) Appl. No.: 15/948,093

(22) Filed: Apr. 9, 2018

(30) Foreign Application Priority Data
Apr. 12, 2017 (JP) 2017-078939

(51) Int. Cl. B60R 21/0132; G07C 5/08

(52) U.S. Cl. CPC B60R 21/0132; B60R 2021/01286; B60R 2021/01322; G07C 5/085

(57) ABSTRACT

A collision data storage device includes: an electronic control unit; and a storage device, wherein the electronic control unit is configured to: acquire a vehicle speed; determine a threshold value smaller when the vehicle is traveling at a low speed than when the vehicle is traveling at a high speed, and detect a collision of the vehicle when an amount of change in the vehicle speed is equal to or greater than the threshold value, and output, to the storage device, data of the collision detected by the electronic control unit, and the storage device is configured to store data of the collision.

### INCORPORATION BY REFERENCE

The disclosure of Japanese Patent Application No. 2017-078939 filed on Apr. 12, 2017 including the specification, drawings and abstract is incorporated herein by reference in its entirety.

### BACKGROUND

### 1. Technical Field

The present disclosure relates to a collision data storage device and a collision data storage method.

### 2. Description of Related Art

Japanese Patent Application Publication No. 2009-175957 (JP 2009-175957 A) discloses a collision determination device that determines whether a vehicle collision will occur. This collision determination device time-integrates the acceleration, applied to the vehicle, to calculate the speed change amount. At the same time, the collision determination device extracts a specific band component that is included in the acceleration and that appears conspicuously at a vehicle collision time, calculates the impact force by calculating the square value of the extracted band component and, with the impact force and the speed change amount as the parameters, determines whether a collision will occur.

### SUMMARY

To avoid a condition in which an impact caused by traveling on a rough road or running over a curb is mistakenly determined as a collision, the collision determination device disclosed in Japanese Patent Application Publication No. 2009-175957 (JP 2009-175957 A) determines that a collision has occurred only in the case when the impact force and the speed change amount of an impact are relatively large. This means that a relatively small collision, if caused while traveling at a low speed, is not determined as a collision. In this case, when collision data generated at the time of collision is collected and analyzed for later use, there is a possibility that some collision data that should be collected cannot be obtained.

In view of the foregoing, the present disclosure provides a collision data storage device and a collision data storage method that can appropriately accumulate data on vehicle collisions.

A collision data storage device according to a first aspect of the present disclosure includes an electronic control unit; and a storage device, wherein the electronic control unit is configured to: acquire a vehicle speed; determine a threshold value smaller when the vehicle is traveling at a low speed than when the vehicle is traveling at a high speed, and detect a collision of the vehicle when an amount of change in the vehicle speed is equal to or greater than the threshold value, and output, to the storage device, data of the collision detected by the electronic control unit, and the storage device is configured to store data of the collision

In the first aspect described above, the electronic control unit may be configured to determine whether the vehicle speed is equal to or lower than a predetermined speed; and determine the threshold value smaller when the threshold value control unit determines the vehicle speed is equal to or lower than the predetermined speed.

In the first aspect described above, the electronic control unit may be configured to: determine whether the vehicle speed is equal to or lower than the predetermined speed; and reset the threshold value to an original value when the threshold value control unit determines the vehicle speed is higher than the predetermined speed.

In the first aspect described above, the electronic control unit may be configured to: determine the threshold value to a first threshold value when the threshold value control unit determines that that the vehicle speed is higher than a predetermined speed; and determine the threshold value to a second threshold value when the threshold value control unit determines that the vehicle speed is equal to or lower than the predetermined speed, wherein the second threshold value is smaller than the first threshold value.

A collision data storage method according to a second aspect of the present disclosure includes acquiring a vehicle speed; setting a threshold value smaller when the vehicle is traveling at a low speed than when the vehicle is traveling at a high speed; determining that a collision has been detected and for outputting data on the collision when an amount of change in the vehicle speed is equal to or greater than the threshold value; and storing data of the collision when it is determined that the collision has been detected.

In the second aspect described above, the setting the threshold value may include: determining whether the vehicle speed is equal to or lower than a predetermined speed; and setting the threshold value smaller when it is determined that the vehicle speed is equal to or lower than the predetermined speed.

In the second aspect described above, the setting the threshold value may include: determining whether the vehicle speed is equal to or lower than the predetermined speed; and resetting the threshold value to an original value when it is determined that the vehicle speed is higher than the predetermined speed.

In the second aspect described above, the setting the threshold value may include: setting the threshold value to a first threshold value when it is determined that the vehicle speed is higher than a predetermined speed; and setting the threshold value to a second threshold value when it is determined that the vehicle speed is equal to or lower than the predetermined speed, wherein the second threshold value is smaller than the first threshold value.

According to the first aspect and the second aspect described above, the collision data storage device and the collision data storage method that can appropriately accumulate data about vehicle collision can be provided.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing an example of a general configuration of a vehicle system that includes a collision data storage device in an embodiment of the present disclosure;

FIG. 2 is a diagram showing an example in which a collision determination threshold value is switched according to the speed of a vehicle in an embodiment of the present disclosure;

FIG. 3A is a diagram showing an example in which the collision detection criterion is switched as the collision determination threshold value is switched, and is a graph in which a normal-time threshold value is set as the collision determination threshold value, in an embodiment of the present disclosure;

FIG. 3B is a diagram showing an example in which the collision detection criterion is switched as the collision determination threshold value is switched, and is a graph in which a low-speed-time threshold value is set as the collision determination threshold value, in an embodiment of the present disclosure;

FIG. 4 is a flowchart showing an example of the operation of a vehicle system in the embodiment of the present disclosure shown in FIG. 1; and

FIG. 5 is a schematic diagram showing a concept of a collision detection method in a modification of the embodiment of the present disclosure.

### DETAILED DESCRIPTION OF EMBODIMENTS

A preferred embodiment of the present disclosure will be described in detail below with reference to the attached drawings. In the figures below, the components with the same reference numeral have the same or similar configuration.

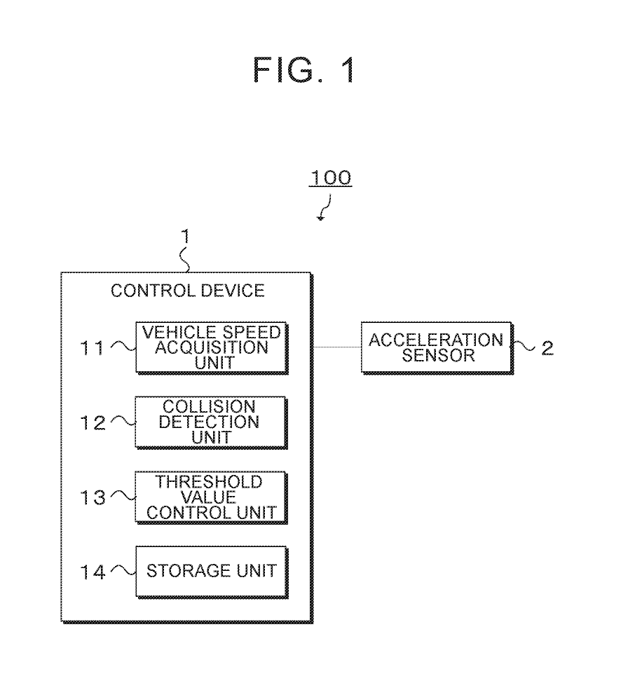

A configuration of a vehicle system that includes a control device, which is a collision data storage device in this embodiment, will be described below with reference to FIG. 1. For example, a vehicle system 100 includes a control device 1 and an acceleration sensor 2. The control device 1 is a computer system for controlling all components mounted on a vehicle.

The control device 1 includes, for example, a vehicle speed acquisition unit 11, a collision detection unit 12, a threshold value control unit 13, and a storage unit 14. Note that the components of the control device 1 are not limited those described above, and any other components may be added as necessary.

The control device 1 is configured by a control unit that includes, for example, a Central Processing Unit (CPU) and a memory (a volatile memory and a nonvolatile memory). The control device 1 may be configured by a single control unit or a plurality of control units.

The storage unit 14 stores various programs and various information necessary for executing the processing in the control device 1. The storage unit 14 includes a volatile memory and a nonvolatile memory. As an example in this embodiment, the storage unit 14 includes a non-volatile memory that records collision data on a collision generated each time a collision is detected.

The control device 1 causes the CPU to execute predetermined programs, stored in the memory, to implement the functions of the vehicle speed acquisition unit 11, the collision detection unit 12, and the threshold value control unit 13. The functions will be described in detail below.

The vehicle speed acquisition unit 11 acquires a vehicle speed. The vehicle speed can be calculated by integrating the measurement value of the acceleration sensor 2. The vehicle speed may be calculated by the vehicle speed acquisition unit 11 or by the acceleration sensor 2.

The collision detection unit 12 determines that a collision has been detected if the vehicle speed change amount is equal to or greater than a predetermined threshold value. The speed change amount may be calculated based on the measurement value of the acceleration sensor 2 or may be calculated based on the vehicle speed acquired by the vehicle speed acquisition unit 11. The predetermined threshold value is a collision determination threshold value based on which it is determined whether a collision has occurred.

The threshold value control unit 13 determines whether the vehicle is traveling at a low speed. Whether the vehicle is traveling at a low speed can be determined based on whether the vehicle speed is equal to or lower than a predetermined speed.

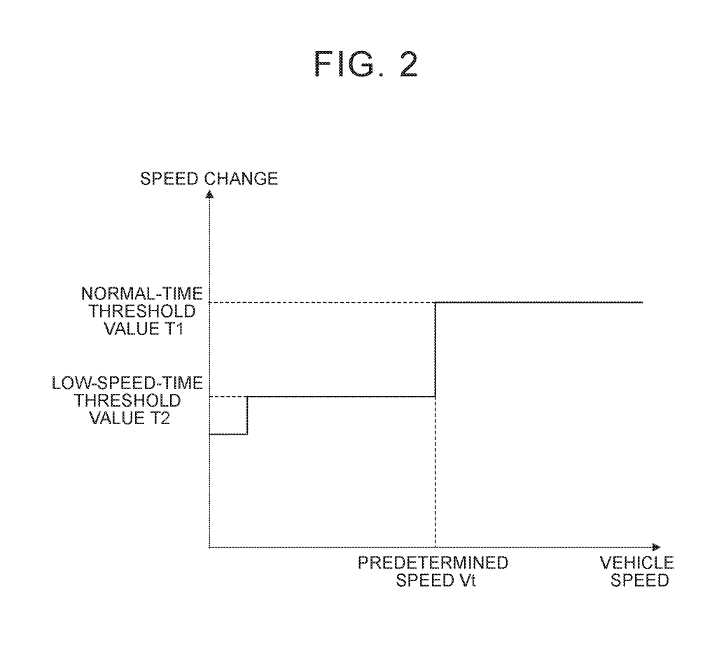

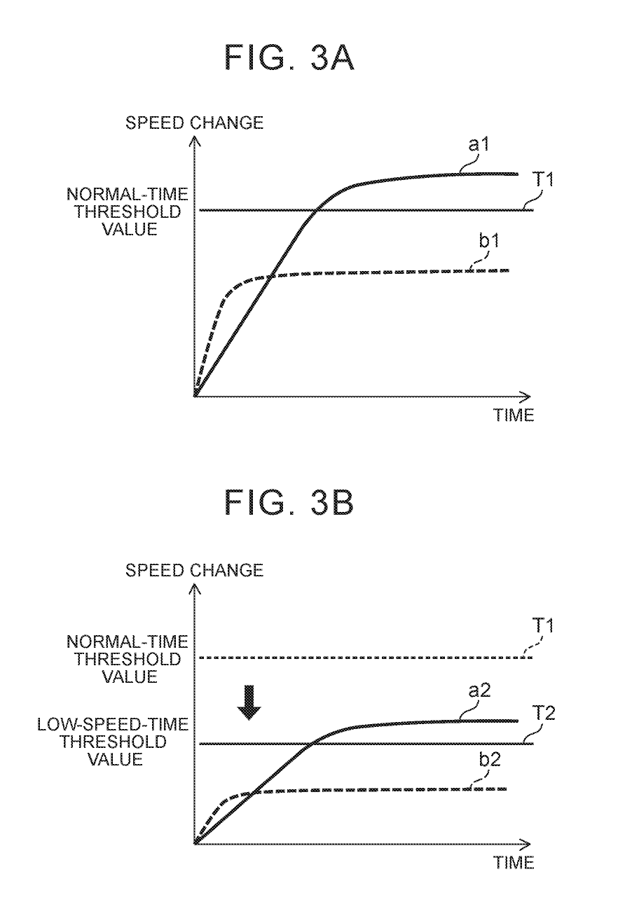

If it is determined that the vehicle speed is equal to or lower than the predetermined speed, the threshold value control unit 13 sets the collision determination threshold value smaller than if it is determined that the vehicle speed is higher than the predetermined speed. In other words, if it is determined that the vehicle speed is equal to or lower than the predetermined speed, the threshold value control unit 13 changes the collision determination threshold value from the normal-time threshold value to a low-speed-time threshold value. The low-speed-time threshold value is set to a value smaller than the normal-time threshold value. The processing performed by the threshold value control unit 13 to set the collision determination threshold value will be described below with reference to FIG. 2, FIG. 3A, and FIG. 3B.

If the vehicle speed is equal to or lower than the predetermined speed Vt, the threshold value control unit 13 sets the collision determination threshold value to the low-speed-time threshold value T2 as shown in FIG. 2. On the other hand, if the vehicle speed is higher than the predetermined speed Vt, the threshold value control unit 13 sets the collision determination threshold value to the normal-time threshold value T1.

Note that the predetermined speed is not limited to one speed, but a plurality of predetermined speeds may be set. When there is a plurality of predetermined speeds, the collision determination threshold value is set to a larger value as the predetermined speed increases.

FIG. 3A is a graph in which the normal-time threshold value T1 is set as the collision determination threshold value. Graph a1 shows an example of the waveform when the speed change amount becomes greater than the normal-time threshold value T1. In the part of this graph a1 where the speed change amount is equal to or greater than the normal-time threshold value T1, a collision is detected by the collision detection unit 12.

Graph b1 shows an example of the waveform when the speed change amount does not reach the normal-time threshold value T1. In the case of this graph b1, a collision is not detected by the collision detection unit 12.

When the vehicle speed is in a medium to high speed range in which the vehicle speed is higher than a predetermined speed Vt, a certain speed change occurs when a collision, even if small, occurs. Therefore, it is preferable to set the normal-time threshold value T1 in a range in which a collision that is small but is desired to be detected can be detected.

On the other hand, when the vehicle speed is in a medium to high speed range, a speed change can be generated easily also by a non-collision impact that is caused, for example, when the vehicle travels on a bad road or over a pothole or when braking is applied suddenly. Therefore, it is preferable to set the normal-time threshold value T1 in a range in which such an impact is not detected as a collision as much as possible.

FIG. 3B is a graph in which the low-speed-time threshold value T2 is set as the collision determination threshold value. Graph a2 shows an example of the waveform when the speed change amount is greater than the low-speed-time threshold value T2. In the part of this graph a2 where the speed change amount is equal to or greater than the low-speed-time threshold value T2, a collision is detected by the collision detection unit 12.

Since the speed change amount indicated by graph a2 does not reach the normal-time threshold value T1, a collision is not detected if the vehicle speed is higher than the predetermined speed Vt.

Graph b2 shows an example of the waveform when the speed change amount does not reach the low-speed-time threshold value T2. In the case of this graph b2, a collision is not detected by the collision detection unit 12.

When the vehicle speed is in a low speed range in which the vehicle speed is equal to or lower than the predetermined speed Vt, a speed change rarely occurs when a small collision occurs. Therefore, it is preferable to set the low-speed-time threshold value T2 in a range in which a collision that is small but is desired to be detected can be detected.

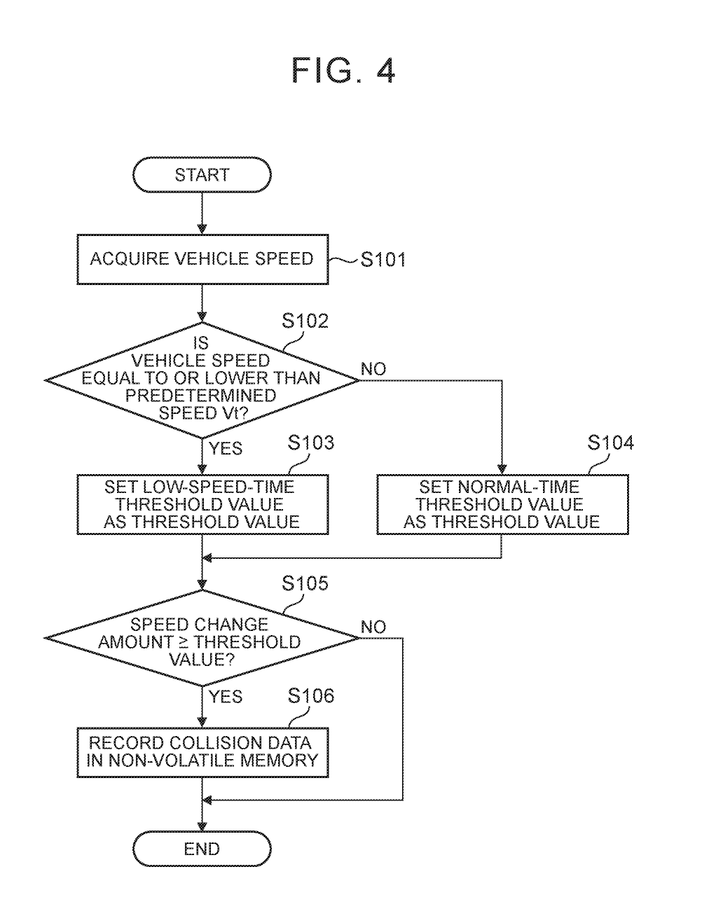

Next, with reference to FIG. 4, an example of the operation of the vehicle system 100 in the embodiment will be described. The processing procedure shown in this figure is repeatedly executed while the vehicle travels.

First, the vehicle speed acquisition unit 11 acquires the vehicle speed (step S101).

Next, the threshold value control unit 13 determines whether the vehicle speed is equal to or lower than the predetermined speed (step S102). If the result of this determination is NO (step S102; NO), the threshold value control unit 13 sets the normal-time threshold value as the collision determination threshold value (step S104). Then, the processing proceeds to step S105 that will be described later.

On the other hand, if it is determined in step S102 described above that the vehicle speed is equal to or lower than the predetermined speed (step S102; YES), the threshold value control unit 13 sets the low-speed-time threshold value as the collision determination threshold value (step S103).

Next, the collision detection unit 12 determines whether the vehicle speed change amount is equal to or greater than the collision determination threshold value (step S105). If the result of this determination is NO (step S105; NO), the processing procedure is terminated. After that, if the vehicle is traveling, the processing proceeds to step S101 described above.

If it is determined in step S105 that the vehicle speed change amount is equal to or greater than the collision determination threshold value (step S105; YES), the collision detection unit 12 records the collision data in the nonvolatile memory (step S106). Then, the processing procedure is terminated. After that, if the vehicle is traveling, the processing proceeds to step S101 described above.

As described above, in the vehicle system 100 in this embodiment, the vehicle speed is acquired and, based on the acquired vehicle speed, the vehicle speed change amount is calculated. If the calculated vehicle speed change amount is equal to or greater than the collision determination threshold value, it is determined that a collision has been detected and the detected collision data can be stored. In addition, when the vehicle is traveling at a low speed, the collision determination threshold value can be set lower than when the vehicle is traveling at a high speed.

As described above, the collision determination threshold value can set smaller when the vehicle is traveling at a low speed than when the vehicle is traveling at a high speed. This makes it possible to detect even a small collision generated at low-speed traveling time during which a speed change rarely occur, thus enabling the resulting collision data to be stored in the memory. On the other hand, when the vehicle is traveling at a medium to high speed, the collision determination threshold value can be reset to the normal-time threshold value. This can reduce a situation in which a non-collision impact, which is likely to occur at a medium to high speed, is mistakenly detected as a collision and the collision data in the memory is overwritten by the data on the non-collision impact.

Therefore, the vehicle system 100 in the embodiment allows vehicle collision data to be accumulated appropriately.

The present disclosure is not limited to the above-described embodiment but can be implemented in various other forms. Therefore, the above-described embodiment is only illustrative in all respects and is not to be construed as limiting. For example, the order of the processing steps described above may be arbitrarily changed or some of the processing steps may be executed in parallel as long as there is no inconsistency in the processing contents.

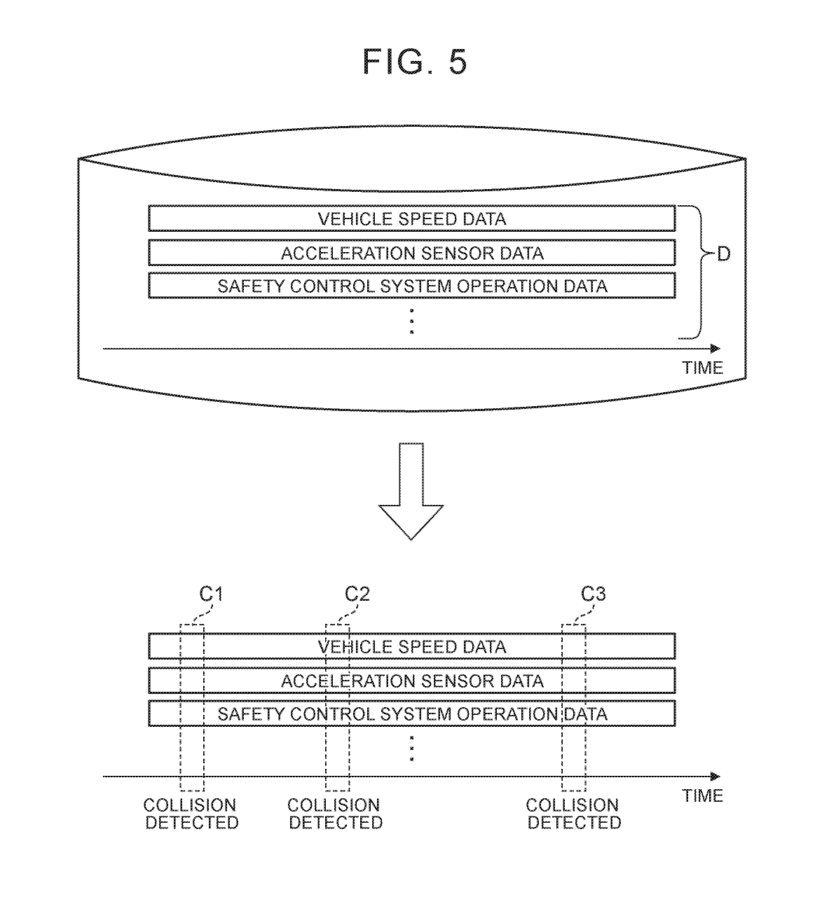

In the embodiment described above, the collision detection unit 12 detects a collision by determining whether the vehicle speed change amount is equal to or greater than the collision determination threshold value. The method for detecting a collision is not limited to the method described above. For example, as shown in FIG. 5, it is possible to accumulate the vehicle data D, including the vehicle speed data, acceleration sensor data, and safety control system operation data, on a time series basis, to calculate the vehicle behavior data (for example, longitudinal acceleration and lateral acceleration) based on the vehicle speed data and the acceleration sensor data that have been accumulated, and to detect the vehicle collisions C1 to C3 based on the behavior data and the safety control system operation data. At this time, if the safety control system is not in operation and if the behavior data is equal to or less than the predetermined threshold value, it may be determined that an impact, if detected, is not a collision and, in this case, the corresponding vehicle collision may be excluded from the vehicle collisions C1 to C3.

What is claimed is:

1. A collision data storage device comprising:
an electronic control unit; and
a storage device, wherein
the electronic control unit is configured to:
acquire a vehicle speed;
determine a threshold value smaller when the vehicle is traveling at a low speed than when the vehicle is traveling at a high speed;
detect a collision of the vehicle when an amount of change in the vehicle speed is equal to or greater than the threshold value; and
output, to the storage device, data of the collision detected by the electronic control unit, and
the storage device is configured to store data of the collision.

2. The collision data storage device according to claim 1, wherein
the electronic control unit is configured to:
determine whether the vehicle speed is equal to or lower than a predetermined speed and;
determine the threshold value smaller when the threshold value control unit determines that the vehicle speed is equal to or lower than the predetermined speed.

3. The collision data storage device according to claim 2, wherein
the electronic control unit is configured to:
determine whether the vehicle speed is equal to or lower than the predetermined speed and;
reset the threshold value to an original value when the threshold value control unit determines that the vehicle speed is higher than the predetermined speed.

4. The collision data storage device according to claim 1, wherein
the electronic control unit is configured to:
determine the threshold value to a first threshold value when the threshold value control unit determines that the vehicle speed is higher than a predetermined speed; and
determine the threshold value to a second threshold value when the threshold value control unit determines that the vehicle speed is equal to or lower than the predetermined speed, the second threshold value being smaller than the first threshold value.

5. A collision data storage method comprising:
acquiring a vehicle speed;
determining a threshold value smaller when the vehicle is traveling at a low speed than when the vehicle is traveling at a high speed;
detecting a collision of the vehicle when an amount of change in the vehicle speed is equal to or greater than the threshold value; and
storing data of the collision when it is determined that the collision has been detected.

6. The collision data storage method according to claim 5, wherein
the determining the threshold value includes:
determining whether the vehicle speed is equal to or lower than a predetermined speed; and
determining the threshold value smaller when it is determined that the vehicle speed is equal to or lower than the predetermined speed.

7. The collision data storage method according to claim 6, wherein
the determining the threshold value includes:
determining whether the vehicle speed is equal to or lower than the predetermined speed; and
resetting the threshold value to an original value when it is determined that the vehicle speed is higher than the predetermined speed.

8. The collision data storage method according to claim 5, wherein
the determining the threshold value includes:
determining the threshold value to a first threshold value when it is determined that the vehicle speed is higher than a predetermined speed; and
determining the threshold value to a second threshold value when it is determined that the vehicle speed is equal to or lower than the predetermined speed, the second threshold value being smaller than the first threshold value.
